(19) United States
(12) Patent Application Publication
(10) Pub. No.: US 2008/0178751 A1
(43) Pub. Date: Jul. 31, 2008

(54) Pneumatic Bale Density Control System

(75) Inventor: Scott D. Seaver, Montague, MI (US)

Correspondence Address: Scott D. Seaver, 4346 West Roosevelt Road, Montague, MI, 49437, US

(73) Assignee: Mr. Scott Daniel Seaver, Montague, MI (US)

(21) Appl. No.: 12/021,331

(22) Filed: Jan. 29, 2008

Related U.S. Application Data
(60) Provisional application No. 60/897,931, filed on Jan. 29, 2007.

(51) Int. Cl. A01F 15/00

(52) U.S. Cl. 100/50; 56/10.2 R; 56/341

(57) ABSTRACT

A density control system for a square baler that uses pneumatic pressure, namely an air spring (1) in conjunction with an air tank (13), to maintain constant pressure on bale tensioning rails (7&8) as material passes through. The air spring (1) expands and contracts to take up changes in the position of the bale tensioning rails because it is connected directly to the air tank (13) allowing air to flow freely in and out of the air spring (1). This holds the pneumatic pressure in the system nearly constant at all times—which is key to maintaining consistent bale density.

### CROSS-REFERENCE TO RELATED APPLICATIONS

This application claims the benefit of provisional patent application APPL No. 60/897,931, filed Jan. 29, 2007 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to agricultural balers, often called square balers, for packaging loose material, such as hay and straw, into a rectangular package called a bale and more particularly to a system for accurately controlling the density of bales produced by square balers.

2. Prior Art

Agricultural balers have a pickup system for picking loose material, such as hay or stray, off the field and a transfer system to move the material from the pickup to the bale forming chamber. The bale forming chamber is made up of 4 sides at least one of which is moveable. The material is forced into the bale forming area with a plunger. As a bale is being formed in the chamber, its density can be controlled by adjusting the size of cross section of the chamber. This is usually accomplished by one or more moveable tensioning rails which are used to apply force that changes the dimensions (height or width) of the chamber opening as the material is forced through.

The objective of a density control system is to maintain consistent bale density during the course of operation. In order to achieve this, there must be a constant force applied to the tensioning rails no matter how far apart they are at any one time. With prior art, force is applied to the tensioning rails using either (a) coil springs that need to be manually adjusted by a hand crank, or (b) hydraulic cylinder and pressure regulator. For example, U.S. Pat. No. 2,576,784 uses a hydraulic cylinder to change the cross sectional area of the bale chute. These spring tensioning or hydraulic tensioning devices can only maintain a constant force on the tensioning rails if the distance between the tensioning rails does not change. The problem is that it is quite common for the distance between the tensioning rails to vary by several inches when there are changes in field conditions, such as a change in type of material such as alfalfa, grass, etc. and an increase or decrease in speed at which the materials are entering the chamber.

This presents the main disadvantage of prior art in that when the distance between the tensioning rails decreases, the force applied to the tensioning rails decreases significantly which is exactly the opposite of what would be desired. The reverse is true when the distance increases—resulting in applying more pressure to the bale at a time when less is desired. Because it is quite common for field conditions to change while baling, prior art is often not able to maintain consistent bale density, which leads to bales that are either to loose or too tight.

In addition to the main problem of often producing bales that too loose or too tight, there are other disadvantages of prior art. For example, hand cranks can be difficult to turn causing opportunity for ergonomic injuries. Additionally, hydraulic systems can leak oil onto the material as it flows through the baler—this can be a problem as the material is often used for animal feed. While more sophisticated hydraulic systems with PID controllers, pressure transducers, and servo valves (U.S. Pat. No. 5,819,643 & 6,112,507) are able to adequately control bale density, their cost is often prohibitive and the sophisticated sensors and electronics used in this prior art are more susceptible to failure in the dusty high, vibration atmosphere that are normal for baling operations.

3. Objects and Advantages

In light of the disadvantage of prior art, an important object of the present invention is to provide a density control system that can maintain consistent bale density even when there are frequent changes in field conditions, and to do so without the need for frequent manual adjustments to the level of pressure applied to the tensioning rails.

The primary advantage of the present invention over prior art is that as the distance between the tensioning rails increases or decreases from one end of the field to another the pressure being applied to the tensioning rails remains nearly constant. This is because the present invention uses a compressible fluid in conjunction with a large pneumatic spring (namely an air spring) and a ballast tank. The air spring expands and contracts to take up changes in the dimension of the bale chamber. This is possible because the air bag is connected to the ballast tank so air can flow freely in and out of the air spring—holding the air pressure in the system nearly constant at all times. Constant air pressure in the system means constant force is being applied to the tensioning rails—which is the key to maintaining consistent bale density.

Since the air spring can accommodate many variations in field conditions a lot of time is saved by the baler operator as he/she is no longer required to make frequent stops while baling to check and adjust bale density. Fewer stops means more bales per hour and better quality feed since more material can be baled at the optimum quality level.

Accordingly, the reader will see that because of the present invention, a typical baling operation will realize a decrease in the number of bales that are either too loose or too tight. Additionally, baler operators will no longer need to make frequent stops to check tension and manually adjust pressure on the bale chamber every time there is a change in the field conditions. Furthermore, because bales are more consistent and uniform, mechanized hay handling equipment like accumulators and hay stackers are less likely to break bales, plug up or create unstable stacks of hay. Loads of hay stacked for transport over main roads and highways will be more stable making them safer to transport

This system is less expensive than the alternative hydraulic system to purchase and maintain. This invention is an improvement over prior art by eliminating oil and seals to contain the oil. Leaking hydraulic oil not only causes contamination of material passing through the baler but also causes downtime and costly repairs. This invention also eliminates the purchase of expensive sensors and electronic controllers. The possibility of these systems malfunctioning causing down time and costly repairs is eliminated.

A side benefit of this invention is instantaneous response. On a typical baler the plunger will cycle 90 times per minute or 1.5 times per second. However even at these speeds the pneumatic spring will expand and contract with each plunger stroke. This opening up of the tensioning rails every time the plunger strokes reduces the static friction of the material in the bale chute allowing the baling ram to overcome the static friction easier. This reduces wear and tear on a baler and increases baler capacity.

### SUMMARY

In a square baler having a bale forming chamber including four walls, at lease one of which wall members includes a tension rail mounted to vary the cross sectional area of said rectangular opening, the improvement comprising a pneumatic spring operable for changing the position of said tension rail, and a pressure equalizing device to maintain constant pneumatic pressure in said pneumatic spring.

### DRAWINGS

### Figures

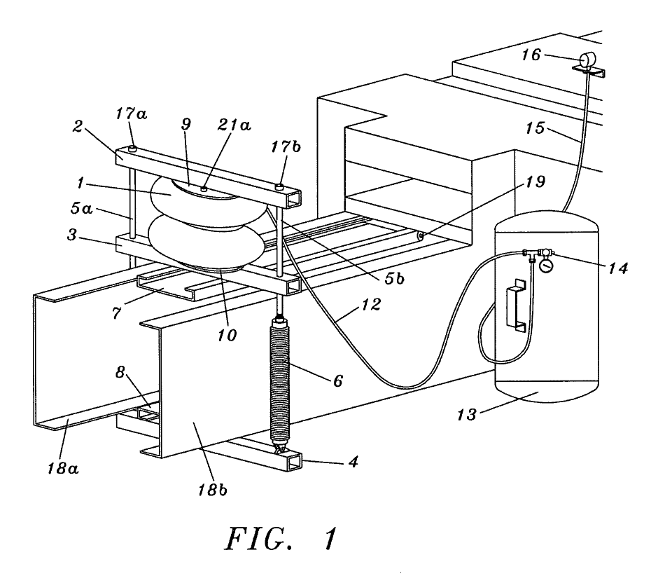

FIG. 1—an isometric view which shows the rear portion of a baler with pneumatic density device installed

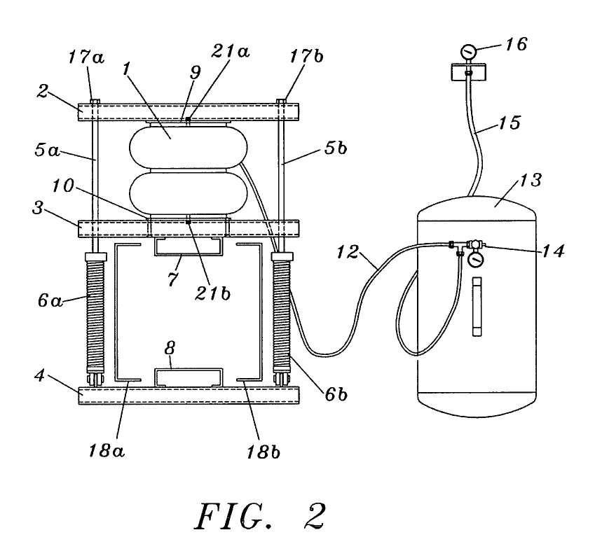

FIG. 2—a rear view which shows how the bale tensioning slides change the cross sectional area of a bale chute

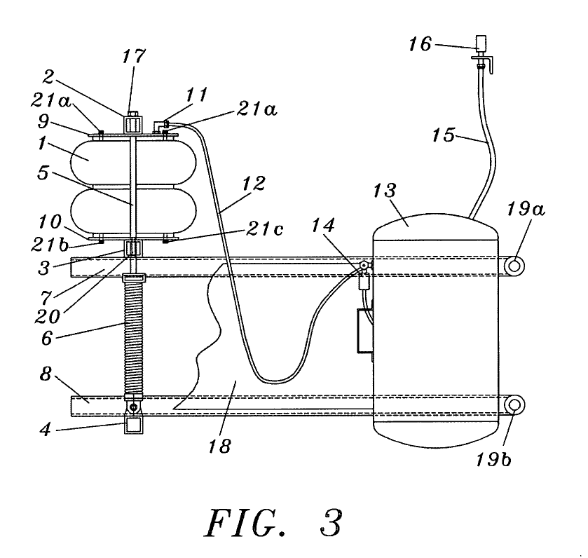

FIG. 3—a side view which shows how tensioning slides pivot and air spring fastening detail

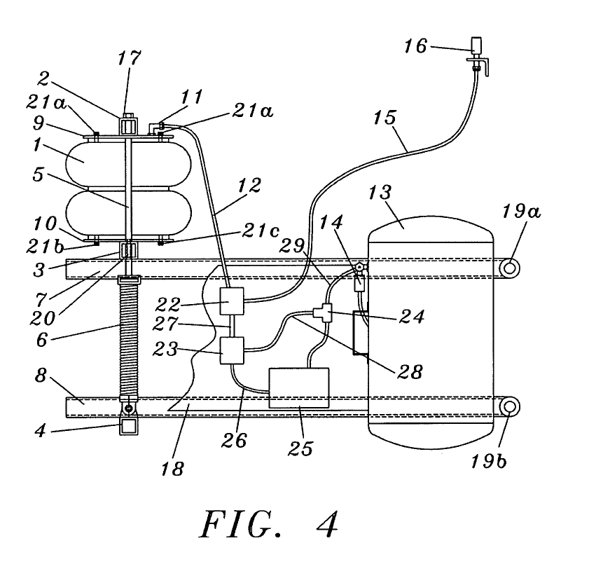

FIG. 4—a side view which shows an alternative method of constant pressure regulation

### DRAWINGS

### Reference Numerals

1 Air spring
2 Upper transverse section
3 Middle transverse section
4 Lower transverse section
5 Threaded connecting rods
6 Springs
7 Upper tensioning rail
8 Lower tensioning rail
9 Top round mounting plate
10 Bottom round mounting plate
11 90° hose barb
12 Air hose (from air spring to air tank)
13 Air tank
14 Air manifold & fill/bleed port
15 Air hose (from air tank to air pressure gauge)
16 Remote pressure gauge
17 Welded nut
18 Bale forming chamber
19 Bale tensioning rail pivot
20 Flat head machine screws
21 Cap head machine screws
22 Air regulator
23 Air pressure switch
24 Hose barb T
25 Air compressor
26 Electrical cord
27 Air hose (connecting pressure switch to pressure regulator)
28 Air hose (connecting T to pressure regulator)
28 Air hose (connecting air compressor to pressure tank)

### DETAILED DESCRIPTION

### FIGS. 1a, 1b, 1c—Preferred Embodiment

My preferred embodiment of the bale tensioning device of the present invention is illustrated in FIG. 1 (Isometric view) FIG. 2 (rear view) and FIG. 3 (side view). Material flows through bale chamber 18 from right to left in each of the figures shown. A Lower tensioning rail 8 pivots around bale tensioning rail pivot 19b and being attached to lower transverse section 4. Lower transverse section 4 is connected to springs 6. Rods 5a and 5b are threaded on each end and pass through middle transverse section 3 and top transverse section 2 then the lower end is threaded into springs 6. Rods 5a and 5b have a welded nut 17a and 17b threaded onto the top and welded in place to prevent unthreading and used in rotating threaded rods 5a and 5b into springs 6 during installation. Middle transverse section 3 is mounted above upper tensioning rail 7 which pivots around bale tensioning rail pivot 19a. A round plate 10 is attached to middle transverse section 3 using flat head screws 20 and a second round plate 9 is welded to the lower side of top transverse section 2. A 12″ diameter air spring 1 is mounted on top of round plate 10 and under round plate 9 using cap screws 20a, b, & c which are threaded into pre-existing holes in air spring 1. 90° hose barb 11 is then threaded into existing air port on air spring 1. Air tank 13 is mounted on the baler in a convenient location, and has an air manifold & fill/bleed port 14. Air manifold & fill/bleed port 14 contains a tire style valve stem for purposes of adding air to the system via a standard tire chuck on an air line. Air manifold & fill/bleed port 14 also contains a spring loaded pressure relief valve for purposes of bleeding air off the system when the pressure gets too high or via manual intervention from an operator to lower air pressure on air spring 1. Air hose 12 (from air spring to air tank) is connected from air spring 1 to air manifold & fill/bleed port 14. Air hose 15 (from air tank to air pressure gauge) is connected from air manifold & fill/bleed port 14 to remote pressure gauge 16. Pressure gauge 16 is located in a location easily viewable from the operator's station.

### Alternative Embodiments

Additional embodiment is demonstrated in FIG. 4. By using the preferred embodiment as described in the above section install air regulator 22, pressure switch 23 and air compressor 25 in a convenient mounting location. Air regulator 22 needs to be of the fill/bleed style to maintain a constant air pressure on the air spring. Remove air hose 12 from air tank 13 and attach to air regulator 22. Install air hose 27 (connecting pressure switch to pressure regulator) from pressure regulator 22 to pressure switch 23. Install electrical cord 26 from pressure switch 23 to air compressor 25. Install air hose 28 from pressure regulator to hose barb T 24. Install air hose 29 to air compressor 25 through hose barb T 24 and finally to air manifold & fill/bleed port 14. Connect air hose 15 to air regulator 22 and air pressure gauge 16.

Other additional embodiments include
A. The preferred embodiment of air spring 1 is a single 12″ diameter bi-lobe air spring with steel mounting plates on top and bottom. Other styles or size air spring such as single lobe, triple lobe, rolling lobe, 9″, 10″ etc can be used. Multiple air springs could also be employed i.e. 2 or 3 etc. A more conventional cylinder having a piston with seals could be used.
B. Force transfer bar 2 in the preferred embodiment is made of 2″×2″ square tubing with 0.250″ wall thickness made of structural steel. Other shapes, sizes, thicknesses, or materials may be used such as rectangle, round, aluminum, titanium etc.
C. Round plates 9 & 10 are made of hot rolled steel and are 0.250″ in thickness but other materials such as aluminum titanium etc. could be used. Other thicknesses could be employed such as 5/16″, ⅜″ etc.
D. Connecting rods 5a and 5b are made of cold rolled steel and are threaded on each end in the preferred embodiment. Other types of connectors could also be used such as chain, cable etc. Different materials could be employed such as aluminum titanium etc.
E. The ballast tank in the preferred embodiment is a 10 gallon air tank of the kind normally used as a portable air tank. However other types of devices which will hold air could be used such as a pressure tank, a sealed frame member on the machine etc.

### Operation

The air density system installed on agricultural baler as described above is filled with compressed air and several bales are run through the baler. Bale density is then checked and air pressure in the system is adjusted accordingly using the air fill/bleed port on air manifold and fill/bleed port 14. Once bale density is satisfactory the air spring 1 will continue to maintain nearly constant force on upper and lower bale tensioning slides 7 & 8. As field conditions change upper and lower bale tensioning slides 7 & 8 will tend to squeeze together and then spread apart. The air spring 1 will continue to maintain a nearly constant force this entire time ensuring a more consistent bale density. Since the air spring 1 can accommodate many variations in field conditions a lot of time is saved by the baler operator as he/she is no longer required to make frequent stops while baling to check and adjust bale density. Fewer stops means more bales per hour and better quality feed since more material can be baled at the optimum quality level.

Operation of the alternative embodiment using pressure regulator 22 would be the same as operation of above except for: When the air pressure in the system needs to be adjusted air regulator 22 would be adjusted to set air pressure desired. Pressure switch 23 would turn on air compressor 25 when air pressure in air tank 13 became too low. In this way a larger amount of pressure in air tank 13 would be used to supply pressure regulator 22. Pressure regulator 22 would use this pressure to add pressure to air spring 1 when pressure went below the set point and conversely pressure regulator 22 would bleed air off to atmosphere when the pressure in air spring 1 exceeded set point.

### Advantages

The most important advantage of the present invention is the provision of a low-maintenance and cost-effective density control system for square balers that is capable of applying constant and uniform pressure on the bale chamber even when there are changes in field conditions.

### CONCLUSION, RAMIFICATIONS, AND SCOPE

Accordingly, the reader will see that because of the present invention, a typical baling operation will realize a decrease in the number of bales that are either too loose or too tight. Additionally, baler operators will no longer need to make frequent stops to check tension and manually adjust pressure on the bale chamber every time there is a change in the field conditions. Furthermore, because bales are more consistent and uniform, mechanized hay handling equipment like accumulators and hay stackers are less likely to break bales, plug up or create unstable stacks of hay.

Although the description above contains many specificities, these should not be construed as limiting the scope of the invention but as merely providing illustrations of the present preferred embodiments of this invention. Thus the scope of the invention should be determined by the appended claims and their legal equivalents, rather than the examples given.

I claim:

1. In a baler having a bale forming chamber including four wall members forming a generally rectangular opening, at lease one of which wall members includes a tension rail mounted to vary the cross sectional area of said rectangular opening, the improvement comprising a pneumatic spring operable for changing the position of said tension rail, and a pressure equalizing device to maintain constant pneumatic pressure in said pneumatic spring.

2. In a baler set worth in claim 1 wherein said pneumatic control means includes a pressure gauge for setting said pneumatic pressure.

3. In a baler set worth in claim 1 wherein said pneumatic control means includes an air fill/bleed line for adjusting said pneumatic pressure.

4. In a baler set worth in claim 1 wherein said pneumatic spring is mounted in such a way as to simultaneously apply force through structural members to one or more movable tensioning slides.

5. In a square baler having a material pickup device, a feeding channel, a bale forming chamber having four wall members at least one of which wall member is moveable to change the cross sectional area of the chamber, the improvement comprising a bale density control system including in combination
a pneumatic spring operable to apply constant and uniform force to said wall members, and
a pressure equalizing device to ensure the pressure in said pneumatic spring remains constant regardless of variations in said pneumatic spring volume.

6. In a baler set worth in claim 5 wherein said pneumatic control means includes a pressure gauge for setting said pneumatic pressure.

7. In a baler set worth in claim 5 wherein said density control system includes a pressure regulator capable of controlling pressure in said pneumatic spring.

8. In a baler set worth in claim 5 wherein said pneumatic spring is mounted in such a way as to simultaneously apply force through structural members to one or more movable tensioning slides.

9. In a square baler having a bale-forming chamber having four wall members at least one of which wall member is moveable to change the cross sectional area of the chamber, the improvement comprising a pneumatic control means to apply consistent force to said wall member during the bale forming process including
a pneumatic spring that expands and contracts to take up changes in the dimensions of the bale chamber, and
a pressure equalization device connected to said pneumatic spring to allow air to flow in and out of said pneumatic spring.

10. In a baler set worth in claim 9 wherein said pneumatic control means includes a pressure gauge for setting said pneumatic pressure.

11. In a baler set worth in claim 9 wherein said density control system includes a pneumatic storage chamber of volume greater than said pneumatic spring.

12. In a baler set worth in claim 9 wherein said pneumatic spring is mounted in such a way as to simultaneously apply force through structural members to one or more movable tensioning slides.
